(19) United States
(12) Patent Application Publication
(10) Pub. No.: US 2026/0014812 A1
(43) Pub. Date: Jan. 15, 2026

(54) RING THREADING DEVICE AND METHOD FOR MANUFACTURING RING NOTEBOOK

(71) Applicant: KOKUYO Co., Ltd., Osaka-shi, Osaka (JP)

(72) Inventor: Yoshiyuki YAMASHITA, Osaka-shi, Osaka (JP)

(21) Appl. No.: 18/995,097

(22) PCT Filed: Nov. 15, 2022
(86) PCT No.: PCT/JP2022/042319

§ 371 Date: Jan. 15, 2025

(51) Int. Cl. B42B 5/10

(52) U.S. Cl. CPC B42B 5/103

(57) ABSTRACT

To allow ring bodies of a ring made of resin or paper to be accurately inserted and to penetrate binding holes of sheets when manufacturing a ring notebook, a ring threading device includes a placement table on which sheets are placed, a positioning jig having a guide roller and nip rollers, and a ring moving mechanism. The positioning jig is a jig for holding a plurality of the ring bodies while maintaining intervals between the ring bodies. The ring moving mechanism is a mechanism for allowing the ring bodies held by the positioning jig to penetrate the binding holes.

### TECHNICAL FIELD

The claimed invention relates to a ring threading device, particularly for allowing a plurality of ring bodies of a ring made of resin or paper to penetrate a plurality of binding holes formed in ends of a plurality of sheets. In addition, the claimed invention relates to a method for manufacturing a ring notebook using the ring threading device.

### BACKGROUND

A ring notebook is a notebook including a plurality of sheets having a plurality of binding holes in an end, which are bound by a ring. The ring is made of metal wire, resin, or paper.

For instance, in a ring notebook as disclosed in JP-A-2015-174413, a plurality of sheets are bound by a ring made of resin. The ring includes a base part and a plurality of ring bodies. The base part is formed to extend in one direction. The plurality of ring bodies each have a predetermined length extending in a direction perpendicular to the extending direction of the base part. In addition, the plurality of ring bodies are arranged at a predetermined pitch.

When manufacturing such a ring notebook, the ring bodies are allowed to penetrate the binding holes, the penetrated parts are bent to form rings, and tip portions thereof are welded to the base part, so that the plurality of sheets are bound. Note that after welding the ring bodies and the base part, parts other than main parts of the welded parts are cut off and disposed as waste.

### SUMMARY OF INVENTION

As described above, in the manufacturing process of the ring notebook, it is necessary to insert the plurality of ring bodies respectively into the binding holes of the sheets. In this case, the following steps are performed, for example. Namely, the ring is positioned with respect to the sheets placed on a table. The ring is moved up or down so as to insert the tip portions of the plurality of ring bodies into the corresponding binding holes, and the ring is further moved up or down so as to allow the ring bodies to penetrate the binding holes.

In the above steps of allowing the ring bodies to penetrate the binding holes, there may be a case where the tip portions of the ring bodies of the resinous ring having low stiffness cannot be accurately inserted into the binding holes, due to misregistration between the ring bodies and the corresponding binding holes of the sheets, which is generated when the ring is moved up or down, although they are positioned beforehand.

Therefore, it is an object of the claimed invention to enable the ring bodies of the ring made of a soft material such as resin or paper to be accurately inserted into and penetrate the binding holes of the sheets when manufacturing the ring notebook.

(1) To accomplish this, a ring threading device according to a first aspect of the claimed invention is a device for allowing a plurality of ring bodies of a ring to penetrate a plurality of binding holes formed in ends of a plurality of sheets. This ring threading device includes a placement table on which the sheets are placed, a positioning jig, and a moving mechanism. The positioning jig is a jig for holding the plurality of ring bodies while maintaining intervals between the ring bodies. The moving mechanism is a mechanism for allowing the ring held by the positioning jig to move relatively to the placement table, so as to allow the ring bodies to penetrate the binding holes.

In this ring threading device, the positioning jig positions the ring bodies with respect to the sheets placed on the placement table. More specifically, the intervals between the ring bodies of the ring are maintained by the positioning jig, and this state is held. In other words, a pitch of the plurality of ring bodies is maintained and held to be a predetermined pitch. Further, the plurality of ring bodies in the state maintained at the predetermined pitch are moved by the moving mechanism relatively to the placement table, and are inserted into the corresponding binding holes of the sheets.

Here, the plurality of ring bodies are each positioned and inserted into the binding holes of the sheets while the positioned state is held, and hence the ring bodies can be accurately inserted into the binding holes, even if the ring is made of a soft material such as resin or paper.

(2) The ring threading device according to a second aspect of the claimed invention is the device of the first aspect, in which the positioning jig includes positioning parts and a connecting part. The positioning parts are disposed corresponding to the plurality of ring bodies, respectively, so as to position the plurality of ring bodies. The connecting part extends in an arrangement direction of the plurality of binding holes of the sheets, so as to connect the plurality of positioning parts.

(3) The ring threading device according to a third aspect of the claimed invention is the device of the first or second aspect, in which the positioning jig is disposed on the same side as the ring with respect to the placement table. Further, the moving mechanism allows the ring bodies positioned and held by the positioning jig to move in a first direction relatively to the placement table, and to penetrate the binding holes.

(4) The ring threading device according to a fourth aspect of the claimed invention is the device of the third aspect, in which a first engaging part is formed on each of the plurality of ring bodies. In addition, the positioning jig has a second engaging part for engaging the first engaging part so that the plurality of ring bodies are positioned and held.

(5) The ring threading device according to a fifth aspect of the claimed invention is the device of the fourth aspect, in which the first engaging part is a protrusion formed on a tip portion of the ring body so as to protrude from a surface thereof, and the second engaging part is a recess to engage with the protrusion.

(6) The ring threading device according to a sixth aspect of the claimed invention is the device of the third aspect, in which the moving mechanism allows only the ring bodies to penetrate the binding holes.

Here, the positioning jig is not inserted into the binding holes, and only the ring bodies penetrate the binding holes. Therefore, a size of the positioning jig is not restricted, and it is easy to produce the positioning jig.

(7) The ring threading device according to a seventh aspect of the claimed invention is the device of the sixth aspect, in which the ring is formed so that the tip portion of the ring body has higher hardness in a predetermined area than other parts.

Here, by double injection molding, for example, the tip portions of the ring bodies are formed to be relatively hard, and hence the tip portions are hardly deformed, and the tip portions of the ring bodies can be easily allowed to penetrate the binding holes.

(8) The ring threading device according to an eighth aspect of the claimed invention is the device of the sixth aspect, in which the positioning jig includes a main body and a holding part. The main body positions each of the plurality of ring bodies. The holding part holds the ring bodies positioned by the main body. In addition, the main body extends in the arrangement direction of the plurality of binding holes of the sheets, and has a surface with guide grooves in which the plurality of ring bodies are respectively engaged. The holding part and the main body sandwich and hold the ring bodies engaged in the guide grooves.

(9) The ring threading device according to a ninth aspect of the claimed invention is the device of the eighth aspect, in which the main body is a rotatable roller having a surface with the guide grooves in which the plurality of ring bodies are respectively engaged. In addition, the holding part is a rotatable nip roller to sandwich and hold the ring bodies engaged in the guide grooves, between itself and the roller. Further, the moving mechanism allows at least one of the roller and the nip roller to rotate.

(10) The ring threading device according to a tenth aspect of the claimed invention is the device of the eighth aspect, in which the main body is a main body bar having a surface with the guide grooves in which the plurality of ring bodies are respectively engaged, the main body bar being capable of approaching and separating from the placement table. In addition, the holding part is a clamp bar that is capable of approaching and separating from the main body bar, and is capable of approaching and separating from the placement table while sandwiching the ring bodies engaged in the guide grooves, between itself and the main body bar. Further, the moving mechanism allows the main body bar and the clamp bar to approach and separate from the placement table.

(11) The ring threading device according to an eleventh aspect of the claimed invention is the device of the second aspect, in which the positioning parts of the positioning jig are capable of moving relatively to the placement table in a direction crossing a placement surface of the placement table, and are capable of penetrating the binding holes of the sheets. Further, the moving mechanism allows the ring bodies as well as the positioning parts holding the ring bodies to penetrate the binding holes.

Here, because not only the ring bodies but also the positioning parts holding the ring bodies are inserted into the binding holes together with the ring bodies, the ring bodies can be inserted into the binding holes more accurately.

(12) The ring threading device according to a twelfth aspect of the claimed invention is the device of the eleventh aspect, in which the positioning jig is disposed on the side opposite to the ring with respect to the placement table. Further, the moving mechanism allows the positioning parts of the positioning jig to move relatively to the placement table, in a first direction so as to penetrate the binding holes, and allows the positioning parts after positioning and holding the ring bodies, to move relatively to the placement table together with the ring bodies in a second direction opposite to the first direction, so as to penetrate the binding holes.

(13) The ring threading device according to a thirteenth aspect of the claimed invention is the device of the twelfth aspect, in which the positioning jig includes a pair of holding parts disposed to face each other and to be capable of approaching and separating from each other.

(14) The ring threading device according to a fourteenth aspect of the claimed invention is the device of the twelfth aspect, in which first engaging parts are formed on the plurality of ring bodies, respectively. Further, the positioning jig includes second engaging parts for engaging the first engaging parts so as to position and hold the plurality of ring bodies.

(15) The ring threading device according to a fifteenth aspect of the claimed invention is the device of the first aspect, in which the moving mechanism moves the ring relatively to the placement table from up to down, so as to allow the ring bodies to penetrate the binding holes of the sheets.

(16) A method for manufacturing a ring notebook according to the claimed invention includes the following steps.

A notebook preparation step: prepare a notebook including a plurality of sheets having a plurality of binding holes arranged in a first direction on one end.

A ring preparation step: prepare a ring including a base part extending in the first direction, and a plurality of ring bodies extending from the base part in a second direction crossing the first direction.

A ring threading step: allow the ring bodies of the ring to penetrate the corresponding binding holes of the notebook, by using the ring threading device according to any one of the aspects described above.

A welding step: deform and bend the ring bodies, and weld the tip portions of the ring bodies to the base part.

A cutting step: cut off tip portions from main parts of welded parts between the ring bodies and the base part.

According to the claimed invention described above, when manufacturing the ring notebook, the ring bodies of the ring made of a soft material such as resin or paper can be accurately inserted into the binding holes of the sheets so as to penetrate the same.

### BRIEF DESCRIPTION OF DRAWINGS

FIG. 1 is an external perspective view of a ring notebook manufactured using a ring threading device according to an embodiment of the claimed invention.

FIG. 2 is a front view of a ring used with the ring threading device.

FIG. 3 is an enlarged partial view of FIG. 2.

FIG. 4 is a cross-sectional view of the ring.

FIG. 5 is a schematic diagram of a manufacturing apparatus for the ring notebook.

FIG. 6 is a schematic diagram of the ring threading device according to a first embodiment.

FIG. 7 is a schematic cross-sectional diagram of the device illustrated in FIG. 6.

FIG. 8 is a cross-sectional view of the sheets and the ring after ring threading and welding steps are finished.

FIG. 9 is a cross-sectional view of the completed ring notebook after a waste cutting step is finished.

FIG. 10 is a schematic diagram of the ring threading according to a second embodiment.

FIG. 11 is a schematic diagram illustrating a bending deformation operation of the ring according to the second embodiment.

FIG. 12 is a schematic diagram of the ring threading according to a third embodiment.

FIG. 13 is a schematic diagram of the ring threading according to a fourth embodiment.

FIG. 14 is a schematic diagram of the ring threading device according to a fifth embodiment.

### DESCRIPTION OF EMBODIMENTS

### First Embodiment

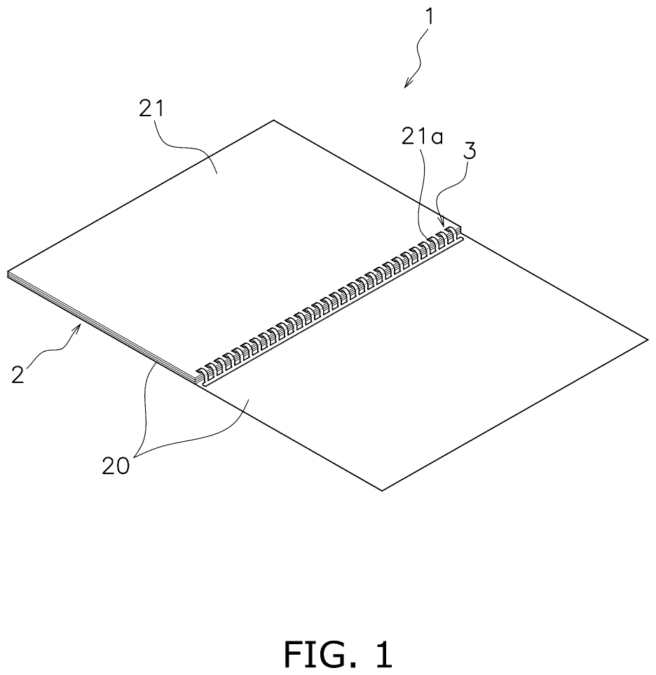

FIG. 1 illustrates a ring notebook 1 manufactured using a ring threading device according to a first embodiment of the claimed invention. The ring notebook 1 includes a plurality of sheets (hereinafter, may be simply referred to as “sheets”) 2 and a ring 3.

### [Sheets 2]

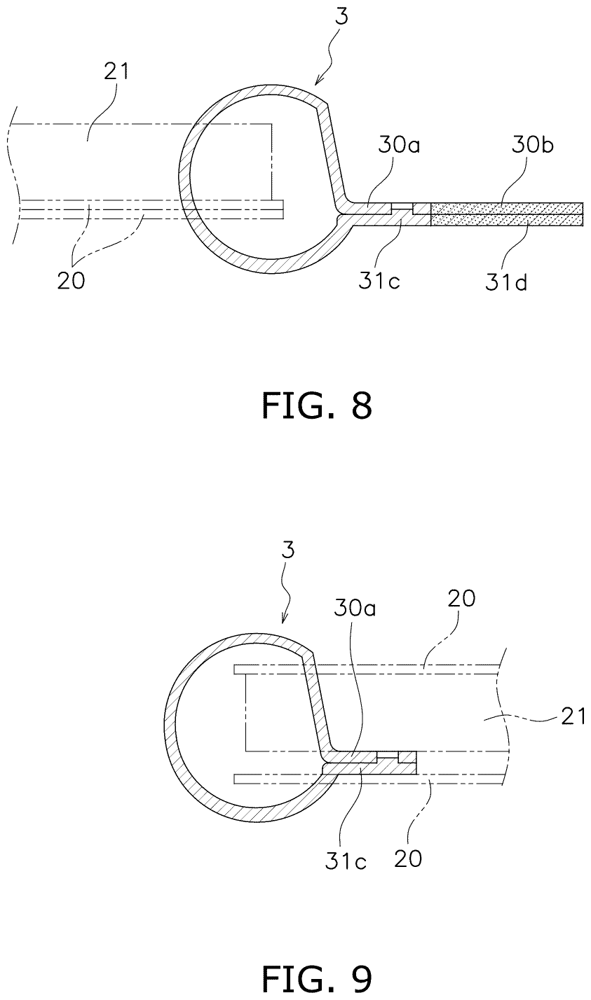

The sheets 2 includes a pair of cover sheets 20 (a front cover sheet and a back cover sheet), and a plurality of inner sheets 21 stacked between the pair of cover sheets 20. In this embodiment, the pair of cover sheets 20 are formed larger than the inner sheets 21 (see FIGS. 8 and 9). On ends of the sheets 2, a plurality of binding holes 21a are formed and arranged at a predetermined pitch.

### [Ring 3]

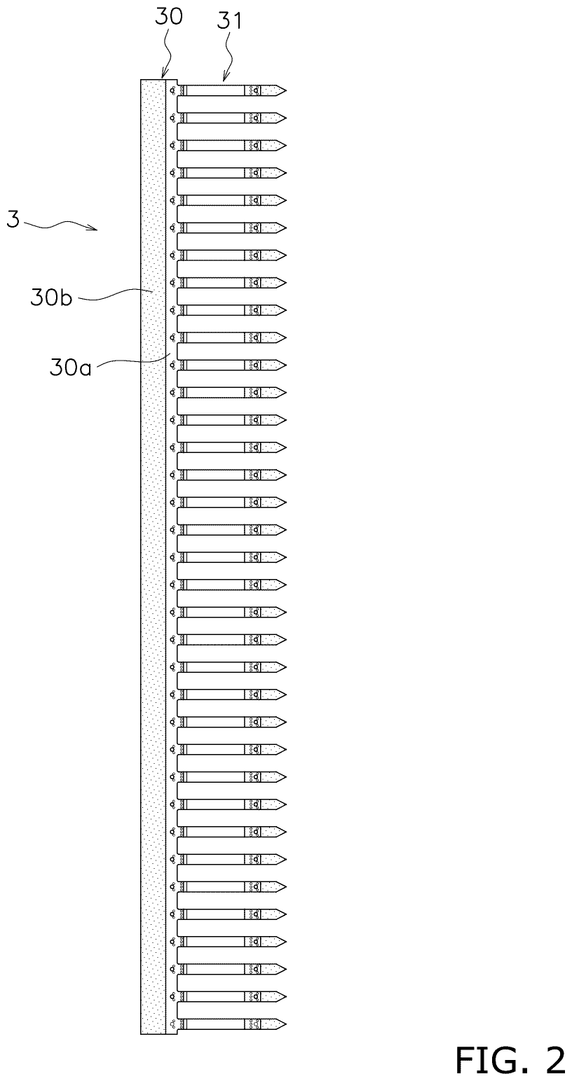

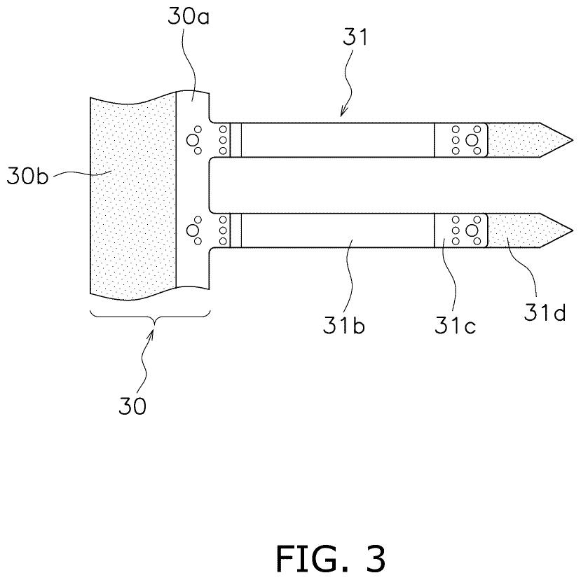

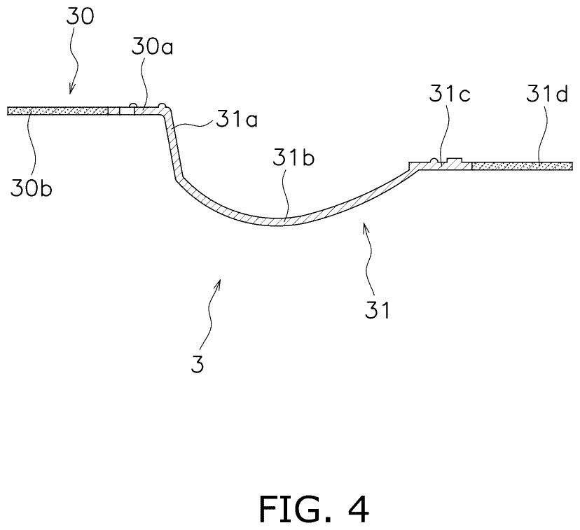

FIGS. 2 to 4 illustrate the ring 3 that is used for the ring notebook 1 of this embodiment. Note that, strictly speaking, the ring 3 illustrated in FIGS. 2 to 4 is not the ring 3 of the ring notebook 1 in its completed state, but is a ring material. In other words, the ring 3 illustrated in these diagrams is one in the state before it is inserted in the binding holes 21a of the sheets 2 so as to bind the sheets. FIG. 3 is an enlarged partial view of FIG. 2, and FIG. 4 is a cross-sectional view of the ring 3.

The ring 3 is made of a synthetic resin. The ring 3 includes a base part 30 and a plurality of ring bodies 31, and the base part 30 and the plurality of ring bodies 31 are integrally formed by injection molding.

The base part 30 extends in an arrangement direction of the binding holes 21a of the sheets 2. The plurality of ring bodies 31 are formed and arranged at the same pitch as that of the plurality of binding holes 21a. In addition, the ring bodies 31 extend from the base part 30 in a direction perpendicular to the extending direction of the base part 30, and have a predetermined length. In the manufacturing process, the ring bodies 31 are inserted in the corresponding binding holes 21a and deformed in a ring shape, and tip portions thereof are welded to the base part 30.

### [Details of Ring 3]

The base part 30 of the ring 3 includes a welding part 30a and a cut-off part 30b. The welding part 30a is an area of the base part 30 formed on a side close to the ring bodies 31. The welding part 30a is a part to which tip portions of the ring bodies 31 are welded. More specifically, the tip portions of the ring bodies 31, which are inserted into the binding holes 21a of the sheets 2 and are bent and deformed in a ring shape, are welded to the welding part 30a. The cut-off part 30b is an area formed on an end of the base part 30 opposite to the ring bodies 31 (illustrated with a plurality of dots in FIGS. 2 and 3), and is a part that is cut off after the tip portions of the ring bodies 31 are welded.

As illustrated in FIGS. 3 and 4, the ring body 31 includes a linear part 31a, a curved part 31b, a welding part 31c, and a cut-off part 31d. The linear part 31a extends in a direction substantially perpendicular to the base part 30. The curved part 31b curves from an end of the linear part 31a so as to be convex outward (in a direction separating from the base part 30). The welding part 31c extends from an end of the curved part 31b in substantially parallel to the base part 30. The cut-off part 31d is an area extending continuously from the welding part 31c, and is a part that is cut off after being welded to the base part 30. In addition, a tip portion of the cut-off part 31d is tapered.

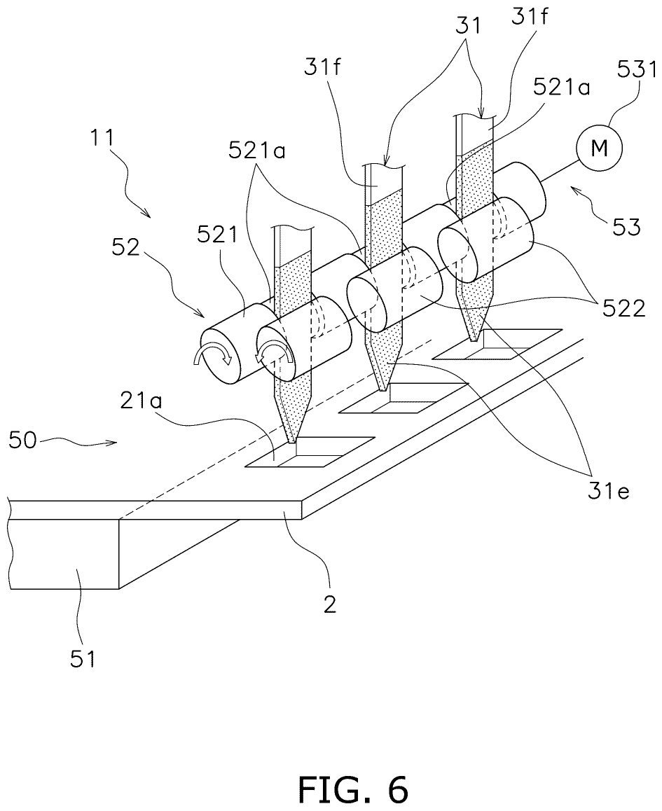

Here, as illustrated in detail in FIG. 6, the ring bodies 31 are formed by double injection molding, using polypropylene resin for predetermined areas 31e of the tip portions (illustrated with a plurality of dots in FIG. 6), and polyethylene resin for other areas 31f (including the base part 30). For this reason, the predetermined areas 31e of the tip portions of the ring bodies 31 have higher hardness and is less deformable than the other parts 31f.

Note that a length of the predetermined area 31e of the tip portion is set to be substantially equal or shorter than that of the cut-off part 31d.

### [Overall View of Manufacturing Apparatus]

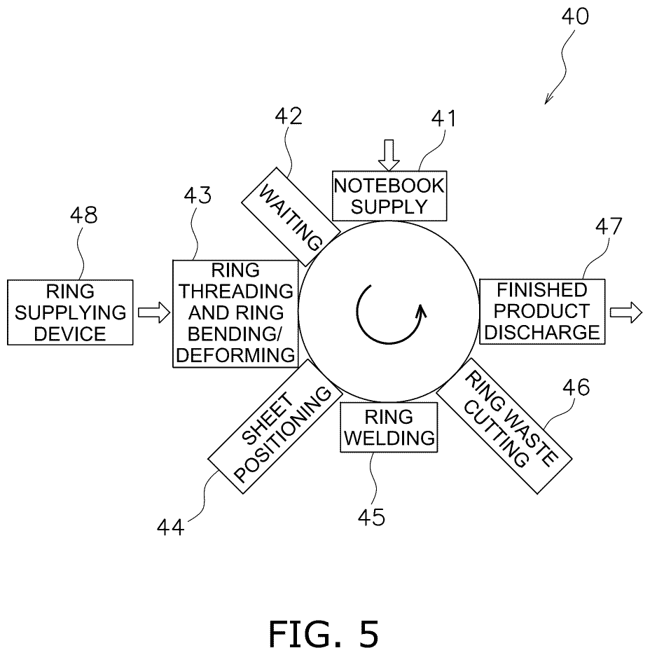

FIG. 5 illustrates an overall schematic diagram of a ring notebook manufacturing apparatus 40. This apparatus 40 includes a notebook supply station 41, a waiting station 42, a ring threading and ring bending/deforming station 43, a sheet positioning station 44, a ring welding station 45, a ring waste cutting station 46, and a finished product discharge station 47, which are arranged in circle in the above order.

In the notebook supply station 41, the sheets 2 with the binding holes 21a formed by another device are supplied. The waiting station 42 is secured as a space that is used for parts replacement or the like. In the ring threading and ring bending/deforming station 43, the ring bodies 31 of the ring 3 are inserted into the binding holes 21a of the sheets 2, and the ring bodies 31 are bent and deformed in a ring shape. In the sheet positioning station 44, positions of the sheets are adjusted for the ring welding step. In the ring welding station 45, the welding parts 31c and the cut-off parts 31d of the ring bodies 31 are welded to the welding parts 30a and the cut-off parts 30b of the base part 30. In the ring waste cutting station 46, the cut-off parts 30b and 31d of the welded base part 30 and ring bodies 31 are cut off. In the finished product discharge station 47, the ring notebook produced by the above steps is discharged.

In this manufacturing apparatus 40, the process in each step can be performed by rotating a jig that holds the sheets in the notebook supply station 41, while maintaining the state where the sheets are held. Therefore, it is not necessary to prepare the jig that holds the sheets in each step. In addition, a mechanism to transfer the sheets between the jigs is not necessary.

### [Ring Threading Device]

FIG. 6 illustrates a ring threading device 11 disposed in the ring threading and ring bending/deforming station 43. The ring threading device 11 is a device for allowing the ring bodies 31 of the ring 3 to penetrate the binding holes 21a of the sheets 2. This ring threading device 11 includes a placement table 51 on which the sheets 2 are placed, a positioning jig 52, and a ring moving mechanism 53. Here, this ring threading device 11 allows only the ring bodies 31 to penetrate the binding holes 21a. In other words, the positioning jig 52 is not inserted into the binding holes 21a.

Note that, although not illustrated in FIG. 6, above the ring threading device 11, there is a jig that grips an upper part of the base part 30 of the ring 3. This jig grips the ring 3 supplied from a ring supplying device 48.

### <Positioning Jig 52>

The positioning jig 52 is a jig for maintaining the plurality of ring bodies 31 at a predetermined pitch, and for holding the plurality of ring bodies 31 in the state maintained at the predetermined pitch.

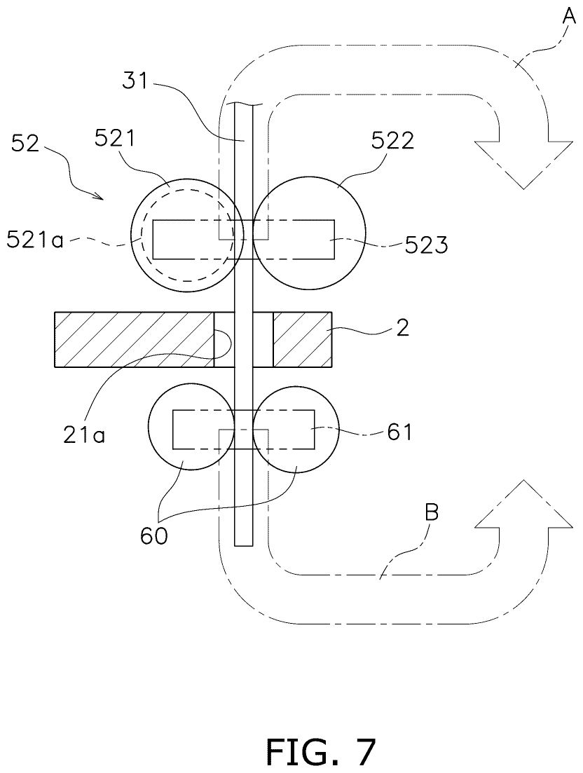

The positioning jig 52 includes a guide roller 521 and a plurality of nip rollers 522. The guide roller 521 extends in the arrangement direction of the binding holes 21a of the sheets 2. Both end portions of the guide roller 521 are supported rotatably by an upper support member 523 illustrated in FIG. 7, and can rotate in a clockwise direction in FIG. 6. On the surface of the guide roller 521, there are guide grooves 521a having substantially the same width and thickness (depth) as the ring bodies 31 so that the ring bodies 31 can be engaged in them. The plurality of nip rollers 522 are disposed to face the guide roller 521 (specifically, the guide grooves 521a). The nip rollers 522 are rotatable and are connected to each other. In addition, as illustrated in FIG. 7, the nip rollers 522 are supported rotatably by the upper support member 523, in a state where a predetermined space is maintained between themselves and the guide roller 521.

A positional relationship between the guide roller 521 and the nip roller 522 is different depending on a size relationship between the guide groove 521a and the ring body 31. Namely, as illustrated in FIG. 7, if the surface of the ring body 31 engaged in the guide groove 521a protrudes from the surface of the guide roller 521, the surface of the nip roller 522 contacts the surface of the ring body 31, but does not contact the surface of the guide roller 521. In contrast, if the surface of the ring body 31 engaged in the guide groove 521a does not protrude from the surface of the guide roller 521, the surface of the nip roller 522 is disposed to contact the surface of the guide roller 521.

Note that the nip rollers 522 may be one roller similarly to the guide roller 521. In addition, the nip roller 522 is driven to rotate following the rotation of the guide roller 521.

### <Ring Moving Mechanism 53>

As illustrated in FIG. 6, the ring moving mechanism 53 includes a motor 531. The motor 531 is disposed at an end portion of the guide roller 521, so as to rotate the guide roller 521 in the clockwise direction in FIG. 6. In this way, the plurality of ring bodies 31, which are engaged in the guide grooves 521a of the guide roller 521 and are maintained at the predetermined pitch, can be inserted into the binding holes 21a while keeping the state.

### [Ring Bending and Deforming Device]

FIG. 7 schematically illustrates the device for bending the ring in a ring shape. Note that FIG. 7 schematically illustrates the ring bodies, and its shape, size, and the like in reality are different.

As illustrated in the diagram, below the placement table (not shown in FIG. 7) on which the sheets 2 are placed, there is a pair of pull-in rollers 60 disposed at a position corresponding to the binding holes 21a. The pair of pull-in rollers 60 are each supported rotatably by a lower support member 61, and are connected with a predetermined space between them. The pair of pull-in rollers 60 sandwich and hold the tip portions of the ring bodies 31 after passing through the binding holes 21a and pull the ring bodies 31 further downward. In addition, although not illustrated, there is a drive mechanism disposed for rotating the upper support member 523 in an arrow A direction in the diagram, and for rotating the lower support member 61 in an arrow B direction.

Using the apparatus described above, the base part 30 of the ring 3 and the ring bodies 31 after passing through the binding holes 21a of the sheets 2 can be bent and deformed in a ring shape, so that the base part 30 of the ring 3 and the tip portions of the ring bodies 31 can be closely contact with each other.

### [Manufacturing Method]

First, using an apparatus other than the manufacturing apparatus 40 illustrated in FIG. 5, the binding holes 20a are formed in the sheets 2. In addition, the rings 3 illustrated in FIG. 2 are stacked and supplied to the ring supplying device 48. Here, as illustrated in FIG. 8, the sheets 2 with the binding holes 21a are supplied to the notebook supply station 41, in a state where the inner sheets 21 are placed on the pair of the cover sheets 20 disposed lower. In this way, because the cover sheets 20 having a larger size are disposed lower than the inner sheets 21 having a smaller size stacked on them, displacement between the cover sheets 20 and the inner sheets 21 can be checked.

The sheets 2 supplied as described above are held by a not-shown jig and are conveyed sequentially in a counterclockwise direction.

In the ring threading and ring bending/deforming station 43, the sheets 2 conveyed from the waiting station 42 are supplied, and the ring 3 is supplied from the ring supplying device 48. Further, using the ring threading device 11 illustrated in FIG. 6, the ring bodies 31 are inserted into the binding holes 21a of the sheets 2 from above, and further using the ring bending and deforming device, the base part 30 and the ring bodies 31 are bent and deformed in a ring shape.

More specifically, the ring bodies 31 are engaged respectively in the guide grooves 521a of the guide roller 521, and are held by the nip rollers 522 in the state where the intervals between the neighboring ring bodies 31 are maintained. Further, the guide roller 521 is driven to rotate by the motor 531, so that the tip portions of the ring bodies 31 are allowed to penetrate the binding holes 21a. The tip portions of the ring bodies 31 after passing through the binding holes 21a are sandwiched and held by the pair of pull-in rollers 60 and are moved further downward.

Next, in the state where the rollers 521, 522, and 60 hold the ring bodies 31, the upper support member 523 above the placement table is rotated in the arrow A direction in the diagram, while the lower support member 61 below the placement table is rotated in the arrow B direction. Note that the not-shown jig that grips the base part 30 of the ring 3 is also rotated in the same manner. In this way, the welding part 30a and the cut-off part 30b of the base part 30 are closely contacted with the welding part 31c and the cut-off part 31d of the ring bodies 31.

In the steps described above, misregistration of the sheets 2 may occur. If the welding process is performed in the next ring welding station 45 with the misregistration of the sheets 2, the sheets 2 may obstruct the ring welding process. Therefore, the sheet positioning station 44 adjusts positions of the sheets 2 and the ring 3, so that the sheets 2 does not obstruct the ring welding process.

Next, in the ring welding station 45, using a conventional known ultrasonic welding mechanism or the like, the base part 30 and the ring bodies 31 are welded with each other.

After the welding is completed as described above, in the ring waste cutting station 46, the cut-off parts 30b and 31d of the base part 30 and the ring bodies 31 are cut off, and the ring notebook 1 is completed.

Note that, as illustrated in FIG. 9, in the completed ring notebook 1, one of the cover sheets 20 and the inner sheets 21 are moved to above the base part 30, while the other cover sheet 20 is moved to below the welding part 31c of the ring bodies 31. In this way, the welding parts 30a and 31c of the base part 30 and the ring bodies 31 are disposed inside the sheets 2 and cannot be visible from the outside.

Here, the plurality of ring bodies 31 are each positioned by the positioning jig 52, and this state is maintained when being inserted into the binding holes 21a. Therefore, the ring bodies 31 can be accurately inserted into the binding holes 21a and penetrate the same. In addition, in this embodiment, the positioning jig 52 is not inserted into the binding holes 21a, but only the ring bodies 31 are inserted. Therefore, a size of the positioning jig 52 is not restricted, and the positioning jig 52 has high design flexibility and is easily produced.

### Second Embodiment

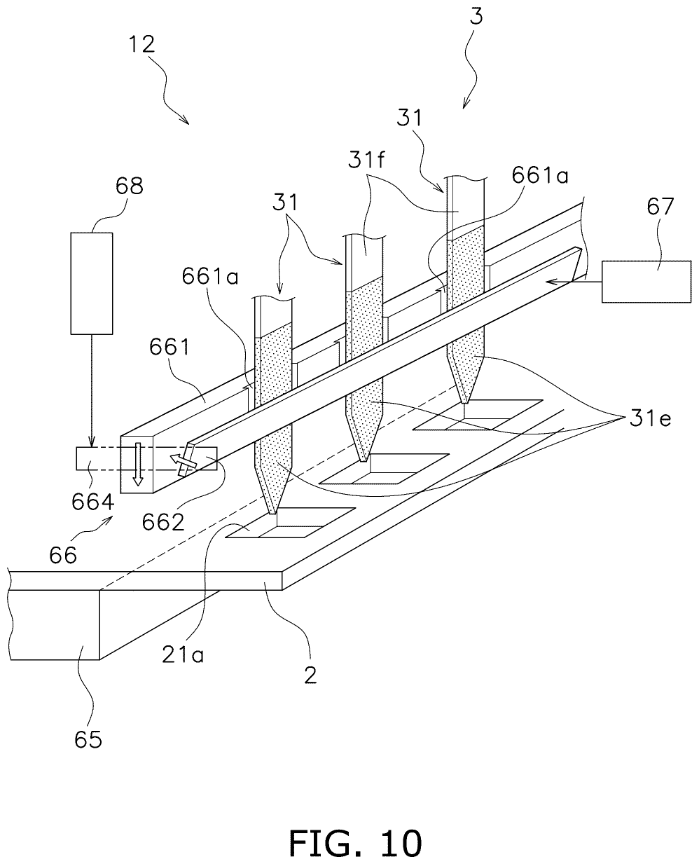

FIG. 10 illustrates a ring threading device 12 according to a second embodiment of the claimed invention. In this ring threading device 12, the positioning jig and the driving mechanism thereof are different from those of the first embodiment, but other structures, the basic operations, and the manufacturing method are the same as those of the first embodiment.

### [Structure]

The ring threading device 12 includes a placement table 65 on which the sheets are placed, a positioning jig 66, a jig moving mechanism 67, and a ring moving mechanism 68. Note that, similarly to the first embodiment, above the ring threading device 12, there is a jig that grips an upper part of the ring. This jig moves downward in synchronization with the positioning jig 66.

Here, the ring used in this second embodiment is formed by double injection molding similarly to the first embodiment. In other words, the predetermined area 31e of the tip portion (illustrated with a plurality of dots in FIG. 10) is formed using polypropylene resin, and the other areas 31f (including the base part 30) is formed using polyethylene resin. For this reason, the predetermined areas 31e of the tip portions of the ring bodies 31 have higher hardness and is less deformable than the other parts 31f.

Note that a length of the predetermined area 31e of the tip portion is set to be equal or a little shorter than that of the cut-off part 31d, similarly to the first embodiment.

This ring threading device 12 allows only the ring bodies 31 to penetrate the binding holes 21a, and the positioning jig 66 is not inserted into the binding holes 21a.

The positioning jig 66 is disposed on the same side as the ring 3, i.e., above the placement table 65. The positioning jig 66 includes a main body bar 661 and a clamp bar 662.

The main body bar 661 extends in the arrangement direction of the binding holes 21a of the sheets, and is movable up and down. The surface of the main body bar 661 has guide grooves 661a formed in substantially the same width and thickness (depth) as the ring bodies 31 so that the ring bodies 31 can be engaged in them. Both ends of the main body bar 661 in the longitudinal direction are immovably supported by support members 664.

The clamp bar 662 is disposed to face the main body bar 661, and extends in the same direction as the main body bar 661. The clamp bar 662 is supported by the support members 664 immovably in the up and down direction, and movably in the horizontal direction.

The jig moving mechanism 67 includes a hydraulic cylinder or the like. This jig moving mechanism 67 enables the clamp bar 662 to approach and separate from the main body bar 661.

The ring moving mechanism 68 includes a hydraulic cylinder or the like. This ring moving mechanism 68 can move the support member 664, so as to move the main body bar 661 and the clamp bar 662 up and down in a synchronous manner.

### [Ring Threading and Bending/Deforming Operation]

First, the ring bodies 31 are each engaged in the guide grooves 661a of the main body bar 661, and are held by the clamp bar 662 in the state where the interval between the neighboring ring bodies 31 is maintained. Further, the main body bar 661 and the clamp bar 662 are moved downward by the ring moving mechanism 68, in the state holding the ring bodies 31, and the tip portions of the ring bodies 31 are allowed to penetrate the binding holes 21a. The tip portions of the ring bodies 31 after passing through the binding holes 21a are sandwiched and held by the pair of pull-in rollers 60, which are similar to the first embodiment, and are moved further downward.

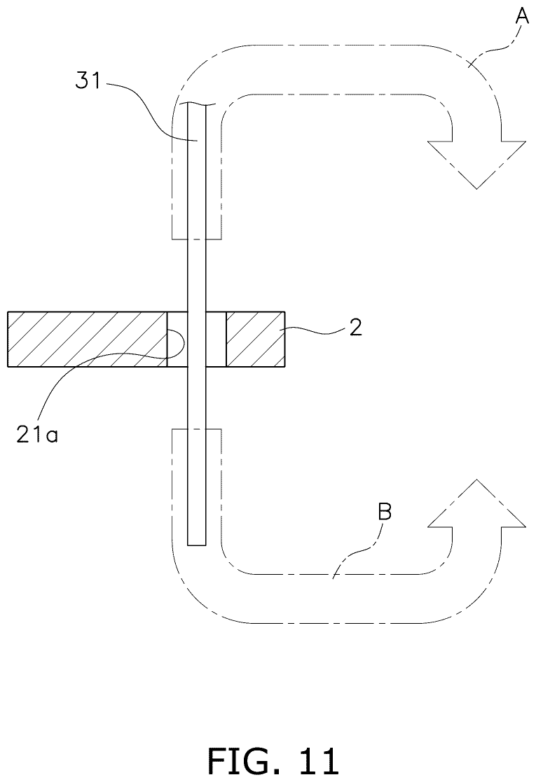

Next, as illustrated in FIG. 11, in the same operation as in the first embodiment, the base part 30 of the ring 3 above the placement table is rotated in the arrow A direction in the diagram, while the tip portions of the ring bodies 31 below placement table are rotated in the arrow B direction. In this way, the ring 3 is bent and deformed, and the welding part 30a and the cut-off part 30b of the base part 30 are closely contacted with the welding parts 31c and the cut-off parts 31d of the ring bodies 31.

As described above, other structures and the manufacturing method are basically the same as those in the first embodiment. Also by this second embodiment, the same effect as the first embodiment can be obtained.

Note that as a variation of this second embodiment, the main body bar 661 and the clamp bar 662 may be provided with extension parts extending downward along the ring bodies 31. In this case, the ring bodies 1 and the positioning jig 66 (the main body bar 661 and the clamp bar 662) are fixed, while the placement table 65 on which the sheets 2 are placed is moved upward, so as to allow the ring bodies 31 as well as the extension parts of the main body bar 661 and the clamp bar 662 to penetrate the binding holes 21a.

In addition, it may be possible to form a hole or notch at a part of the ring body 31 to be clamped, and to form a protrusion that fits with the hole or notch on the clamp bar 662, so that the ring bodies 31 are held by the clamp bar 662 and the main body bar 661.

### Third Embodiment

### [Structure]

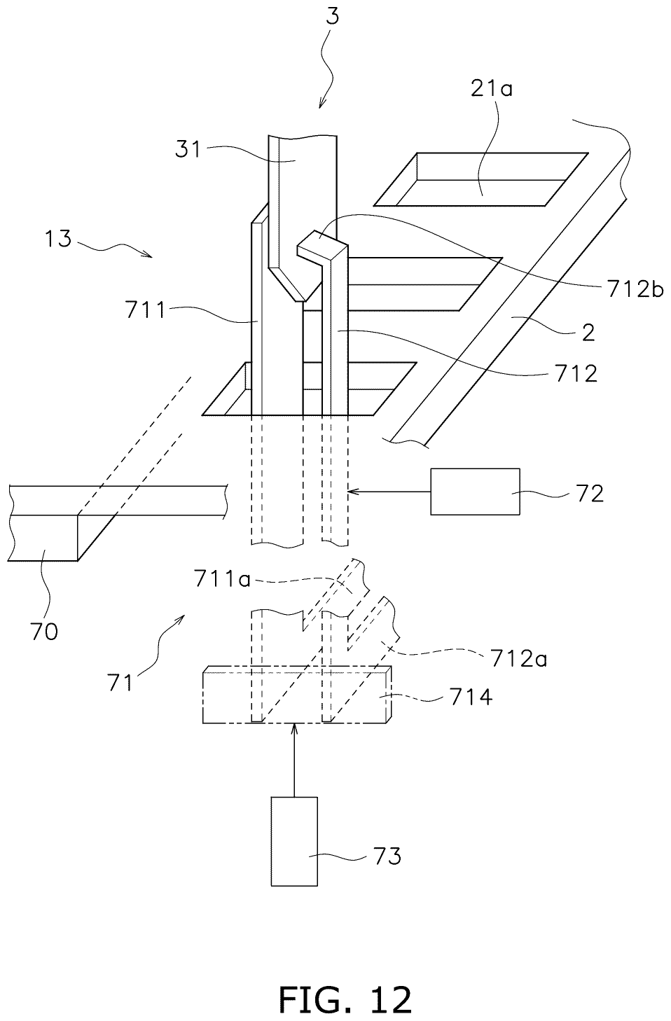

FIG. 12 illustrates a ring threading device 13 according to a third embodiment of the claimed invention. This embodiment uses the ring 3 that is the same as in the first embodiment. The ring threading device 13 includes a placement table 70 on which the sheets are placed, a positioning jig 71, a jig moving mechanism 72, and a ring moving mechanism 73. In this third embodiment, the ring threading device 13 allows not only the ring bodies 31 but also the positioning jig 71 to penetrate the binding holes 21a, together with the ring bodies 31.

The positioning jig 71 is disposed on the side opposite to the ring 3 with respect to the placement table 70. Specifically, in FIG. 12, the ring 3 is supplied to above the placement table 70, and the positioning jig 71 is disposed below the placement table 70. Note that, in the same manner as in the embodiments described above, the upper part of the ring 3 is gripped by a not-shown jig. This jig is moved downward in synchronization with the positioning jig 71.

The positioning jig 71 includes a plurality of pairs of holding parts, each of which includes a first holding tool 711 and a second holding tool 712, corresponding to the plurality of ring bodies 31, i.e., the binding holes 21a of the sheets. Note that in FIG. 12, only one pair of holding tools (the first holding tool 711 and the second holding tool 712) are illustrated, and other pairs are not illustrated.

The first holding tool 711 and the second holding tool 712 are movable up and down, and have shapes that can pass through the binding hole 21a of the sheets. The lower parts of the plurality of the first holding tools 711 are connected to each other by a connecting part 711a. In addition, the lower parts of the second holding tools 712 are also connected to each other by a connecting part 712a.

The first holding tool 711 is a plate elongated in the up and down direction, and both ends of the connecting part 711a in the longitudinal direction are immovably supported by support members 714. Similarly to the first holding tool 711, the second holding tool 712 is a plate elongated in the up and down direction, and is disposed to face the first holding tool 711. A tip portion of the second holding tool 712 include a bent part 712b bent toward the first holding tool 711. As to the second holding tool 712, both ends of the connecting part 712a in the longitudinal direction are supported by the support members 714 immovably in the up and down direction, and movably in the horizontal direction.

The jig moving mechanism 72 includes a hydraulic cylinder or the like. This jig moving mechanism 72 enables the second holding tool 712 to approach and separate from the first holding tool 711.

Note that the connecting part 712a of the second holding tool 712 may be linked to the support member 714 or the connecting part 711a of the first holding tool 711 in a pivotable manner. In this case, when the second holding tool 712 is pivoted, the bent part 712b at the tip thereof can approach and separate from the first holding tool 711.

The ring moving mechanism 73 includes a hydraulic cylinder or the like. This ring moving mechanism 73 enables the first holding tool 711 and the second holding tool 712 supported by the support members 714 to move up and down together with the support member 714.

### [Ring Threading Operation]

First, the ring moving mechanism 73 is driven to allow the first holding tool 711 and the second holding tool 712 to move upward and to penetrate the binding holes 21a. Further, the holding tools 711 and 712 are moved upward until a height at which they can sandwich the tip portions of the ring bodies 31.

Next, the jig moving mechanism 72 is driven to allow the second holding tool 712 to approach the first holding tool 711, so that the holding tools 711 and 712 sandwich and hold the tip portions of the ring bodies 31. In this way, each of the plurality of ring bodies 31 is sandwiched and held by the holding tools 711 and 712, so that the interval between the neighboring ring bodies 31 is maintained and positioned.

After that, the ring moving mechanism 73 is driven to allow the holding tools 711 and 712 sandwiching and holding the ring bodies 31 to move downward in this state, so that the ring bodies 31 as well as the holding tools 711 and 712 are allowed to penetrate the binding holes 21a. In this case, the jig that grips the upper part of the ring 3 also moves downward in a synchronous manner.

Note that, as a variation when the ring 3 as well as the holding tools 711 and 712 are allowed to penetrate the binding holes 21a, it may be possible to fix the ring 3 as well as the holding tools 711 and 712, and to drive the placement table 51 on which the sheets 2 are placed to move upward, so as to allow the ring 3 as well as the holding tools 711 and 712 to penetrate the binding holes 21a.

Next, similarly to the second embodiment, the jig (not shown) that grips the upper part of the ring 3 is rotated in one direction, while the holding tools 711 and 712 are rotated in the other direction. Further, the welding part 30a and the cut-off part 30b of the base part 30 of the ring 3 are closely contacted with the welding part 31c and the cut-off part 31d of the ring bodies 31. The steps after this are the same as those in the first embodiment.

With this ring threading device 13, similarly to the first and second embodiments, the plurality of ring bodies 31 are each positioned, and in the state maintaining the positioned state, they can be inserted into the binding holes 21a. Therefore, the ring bodies 31 can be accurately inserted in the binding holes 21a and allowed to penetrate the same.

In addition, in this third embodiment, the holding tools 711 and 712 grip the ring bodies 31, and in this state they pass through the binding holes 21a together with the ring bodies 31. Therefore, the ring bodies 31 can be allowed to accurately and securely pass through the binding holes 21a.

Note that in this third embodiment, the structure of holding the ring bodies 31 with the pair of holding tools is not limited to that illustrated in FIG. 12 for sandwiching the ring bodies 31. For instance, it may be possible to form a hole or notch in the tip portion of the ring body 31, and to insert the bent part 712b of the second holding tool 712 into the hole or notch, so as to allow the tip portion of the bent part 712b to contact the first holding tool 711 and to catch and hold the ring bodies 31.

### Fourth Embodiment

### [Structure]

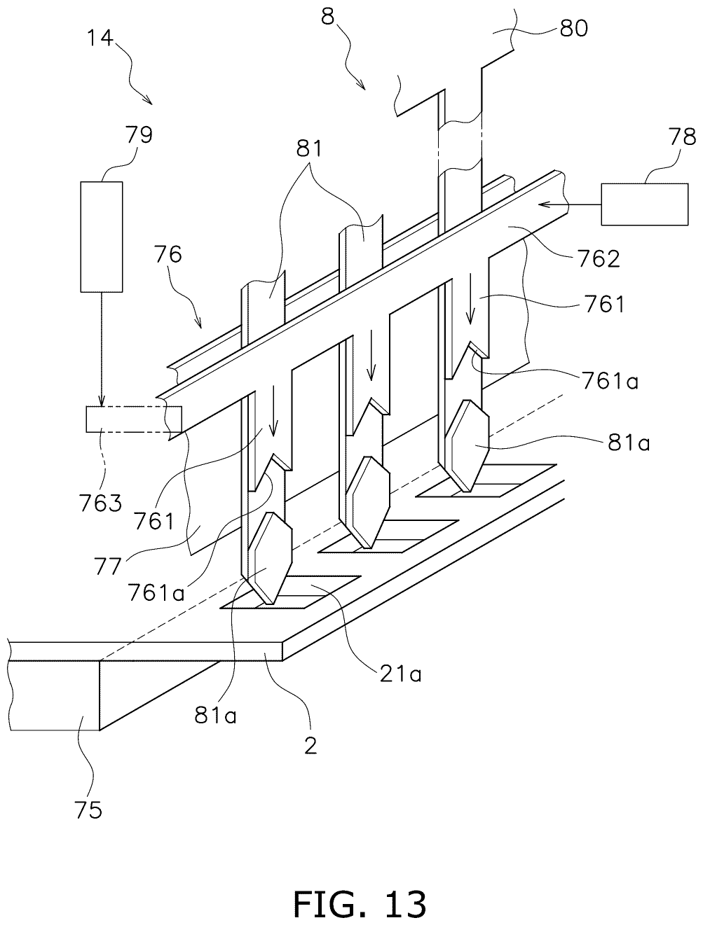

FIG. 13 illustrates a ring threading device 14 according to a fourth embodiment of the claimed invention. This ring threading device 14 includes a placement table 75 on which the sheets are placed, a positioning jig 76, a back plate 77, a jig moving mechanism 78, and a ring moving mechanism 79. In addition, this ring threading device 14 allows not only the ring bodies but also the positioning jig 76 to penetrate the binding holes 21a together with the ring bodies.

This ring threading device 14 uses a ring 8 as illustrated in FIG. 13. Specifically, the ring 8 includes a base part 80 and ring bodies 81. The tip portion of the ring body 81 has an integrally formed protrusion 81a that protrudes from the surface by a predetermined thickness. A lower end portion of the protrusion 81a has a tapered shape similarly to the tip portion of the ring body 81. In addition, an upper end portion of the protrusion 81a has a shape tapered upward.

The positioning jig 76 is disposed above the placement table 75, i.e., on the same side as the ring 8 with respect to the placement table 75, and is movable up and down. The positioning jig 76 is a metal plate, for example, and includes a plurality of positioning parts 761 and a connecting part 762.

The positioning parts 761 are each formed corresponding to the ring bodies 81, i.e., the binding holes 21a of the sheets 2, and each have a shape that can pass through the binding hole 21a of the sheets. In addition, a recess 761a is formed at the tip portion of the positioning part 761. The recess 761a has a shape tapered upward, and can engage with the upper end portion of the protrusion 81a formed on the tip portion of the ring body 81.

The connecting part 762 is formed to extend in the extending direction of the base part 80 of the ring 8. This connecting part 762 connects the upper end portions of the plurality of positioning parts 761. Both end portions of the connecting part 762 in the longitudinal direction are supported by support members 763 immovably in the up and down direction, and movably in the horizontal direction.

The back plate 77 is disposed to face the positioning jig 76. In other words, the back plate 77 is disposed to contact surfaces of the ring bodies 81 on the side opposite to the surfaces contacting the positioning jig 86. This back plate 77 can stabilize an attitude of the ring 8 when the ring 8 is moved downward.

The jig moving mechanism 78 includes a hydraulic cylinder or the like. This jig moving mechanism 78 enables the positioning jig 76 to approach and separate from the back plate 77.

The ring moving mechanism 79 includes a hydraulic cylinder or the like. This ring moving mechanism 79 enables the positioning jig 76 supported by the support members 763 to move up and down together with the support members 763.

### [Ring Threading Operation]

First, the jig moving mechanism 78 allows the positioning jig 76 to approach the back plate 77. As a result, the ring bodies 81 of the ring 8 are sandwiched between the back plate 77 and the positioning jig 76. Next, the ring moving mechanism 79 allows the positioning jig 76 to move downward. In this way, the recess 761a of the positioning part 761 is engaged with the protrusion 81a of the ring bodies 81. In this state, a positional relationship between each of the ring bodies 81 and the positioning part 761 is fixed by the recess 761a of the positioning part 761 and the protrusion 81a of the ring bodies 81, and the interval between the neighboring ring bodies 81 is maintained and positioned. Further, from this state, the positioning jig 76 and the ring 8 are moved downward, and hence the positioning parts 761 of the positioning jig 76 and the ring bodies 81 penetrate the binding holes 21a.

Note that, as a variation when the ring 3 and the positioning jig 76 are allowed to penetrate the binding holes 21a, it may be possible to fix the ring 3 and the positioning jig 76, and to drive the placement table 75 on which the sheets 2 are placed to move upward, so as to allow both the ring bodies 31 and the positioning jig 76 to penetrate the binding holes 21a.

The steps after this are basically the same as those in the embodiments described above. The base part 80 of the ring 8 is rotated in the clockwise direction, while the ring bodies 81 after passing through the binding holes 21a are rotated in the counterclockwise direction, and the welding parts of them are closely contacted with each other.

Also by this fourth embodiment, the same effect as the third embodiment can be obtained.

### Fifth Embodiment

### [Structure]

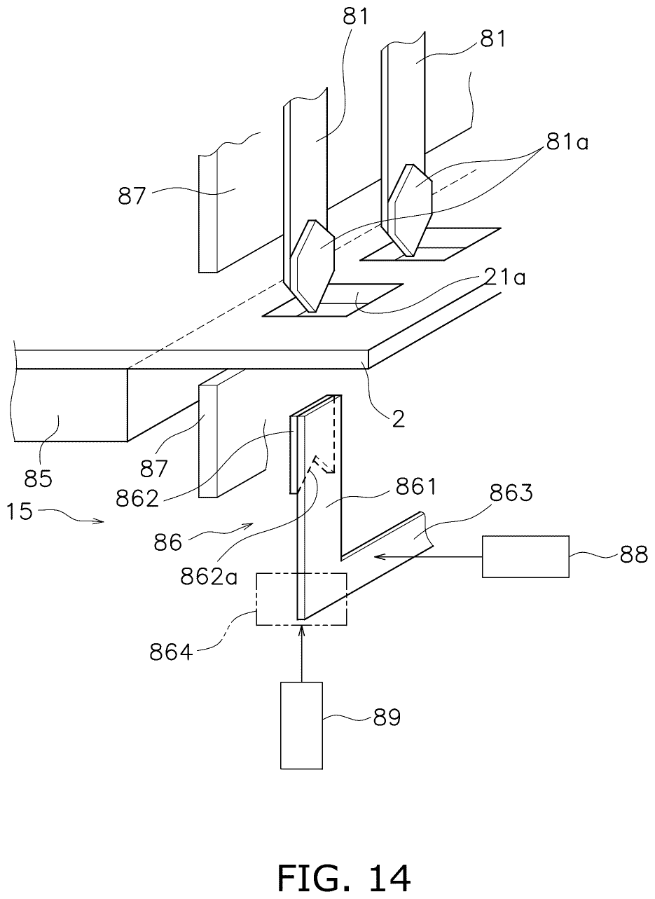

FIG. 14 illustrates a ring threading device 15 according to a fifth embodiment of the claimed invention. This ring threading device 15 includes a placement table 85 on which the sheets are placed, a positioning jig 86, upper and lower back plates 87, a jig moving mechanism 88, and a ring moving mechanism 89. In addition, similarly to the third and fourth embodiments, this ring threading device 15 allows not only the ring bodies but also the positioning jig 86 to penetrate the binding holes 21a together with the ring bodies. Note that this ring threading device 15 uses the ring 8 that is the same as that in the fourth embodiment.

The positioning jig 86 is disposed on the side opposite to the ring 8 with respect to the placement table 85. Specifically, in FIG. 14, the ring 8 is supplied to above the placement table 85, while the positioning jig 86 is disposed below the placement table 85. Note that the upper part of the ring 8 is gripped by a not-shown jig. This jig moves downward in a synchronous manner with the positioning jig 86.

The positioning jig 86 is a metal plate, for example, and includes a plurality of positioning parts 861, engaging parts 862, and a connecting part 863.

The positioning parts 861 are each formed corresponding to the ring bodies 81, i.e., the binding holes 21a of the sheets 2, and each have a shape that can pass through the binding hole 21a of the sheets. The engaging parts 862 are disposed on surfaces of tip portions of the positioning parts 861, on the side facing the back plate 87. The engaging part 862 has a predetermined thickness and has a recess 862a at its lower end portion. The recess 862a has a shape tapered upward, and can engage with the upper end portion of the protrusion 81a of the ring body 81.

The connecting part 863 is formed to extend in the extending direction of the base part 80 of ring 8. This connecting part 863 connects the lower end portions of the plurality of positioning parts 861. Both end portions of the connecting part 863 in the longitudinal direction are supported by support members 864 immovably in the up and down direction, and movably in the horizontal direction.

The upper and lower back plates 87 are disposed above and below the placement table 85 at a position laterally separated from the placement table 85. The back plates 87 are disposed to contact surfaces of the ring bodies 81 on the side opposite to the surfaces contacting the positioning jig 86. This back plate 87 can stabilize an attitude of the ring 8 when the ring 8 is moved downward.

The jig moving mechanism 88 includes a hydraulic cylinder or the like. This jig moving mechanism 88 enables the positioning jig 86 to approach and separate from the back plates 87.

The ring moving mechanism 89 includes a hydraulic cylinder or the like. This ring moving mechanism 89 enables the positioning jig 86 supported by the support members 864 to move up and down together with the support member 864.

### [Ring Threading Operation]

First, the ring moving mechanism 89 allows the positioning jig 86 to move upward, and allows the positioning parts 861 to penetrate the binding holes 21a. Further, it stops the movement of the positioning jig 86 when the engaging part 862 of the positioning jig 86 reaches a position higher than the protrusion 81a of the ring bodies 81.

Next, the jig moving mechanism 88 allows the positioning jig 86 to approach the upper back plate 87, so that the positioning jig 86 and the back plate 87 sandwich and hold the tip portions of the ring bodies 81. In this state, the ring moving mechanism 89 allows the positioning jig 86 to move downward, and then the recesses 862a of the engaging parts 862 engage the protrusions 81a of the ring bodies 81. In this way, the intervals between the ring bodies 81 are maintained and positioned by the positioning jig 86.

After that, the ring moving mechanism 89 allows the ring bodies 81 positioned by the positioning jig 86 to move downward together with the positioning jig 86 and to penetrate the binding holes 21a. In this case, the jig gripping the upper part of the ring 8 also moves downward in a synchronous manner.

Note that as a variation when the ring 3 and the positioning jig 86 are allowed to penetrate the binding holes 21a, it may be possible to fix the ring 3 and the positioning jig 86, and to drive the placement table 85 on which the sheets 2 are placed to move upward, so as to allow both the ring bodies 31 and the positioning jig 86 to penetrate the binding holes 21a.

After this, the operations of bending and deforming the ring in a ring shape and welding the same are the same as those in the embodiments described above.

Also by this ring threading device 15, the same effect as the third or fourth embodiment can be obtained.

Note that, the predetermined area of the tip portions of the ring bodies are formed by double injection molding, so as to have higher hardness than other parts in the first through third embodiments, but it may be possible that the predetermined area has the same hardness as other parts, without using double injection molding. In addition, the ring bodies are allowed to penetrate the binding holes from above the binding holes in every embodiment, but without limiting to this, it may be possible to allow the ring bodies to penetrate the binding holes from below the binding holes. Further, it may be possible to dispose the binding holes to open in the horizontal direction, and to allow the ring bodies to penetrate the binding holes in the horizontal direction.

### Other Embodiments

The claimed invention is not limited to the embodiments described above, but can be variously modified or corrected without deviating from the scope of the claimed invention.

(a) The shape or the like of the positioning jig is not limited to that of the embodiments described above, and it is sufficient that it has a structure that can position the plurality of ring bodies and maintain the state thereof.

(b) Although the hydraulic cylinder is exemplified as the mechanism for moving the positioning jig, it may be other driving mechanism.

(c) The shape or the like of the ring that is used with the ring threading device of the claimed invention is merely an example, and it is not limited to the shape or the like illustrated in the drawings.

(d) In each embodiment described above, the case is described where the ring made of resin is allowed to penetrate the binding holes of the sheets, but the claimed invention can be applied to other general rings such as that made of paper.

### REFERENCE SIGNS LIST

2 sheet
21a binding hole
3 ring
30 ring part
31 ring body
11, 12, 13, 14, 15 ring threading device
51, 65, 70, 75, 85 placement table
52, 66, 71, 76, 86 positioning jig
53, 68, 73, 79, 89 ring moving mechanism
521 guide roller
521a guide groove
522 nip roller
661 main body bar
661a guide groove
662 clamp bar
711, 712 first holding tool, second holding tool
711a, 712a connecting part
761 positioning part
761a recess
762 connecting part
861 positioning part
862 engaging part
862a recess
863 connecting part

1. A ring threading device for allowing a plurality of ring bodies of a ring to penetrate a plurality of binding holes formed in ends of a plurality of sheets, the device comprising:
a placement table on which the sheets are to be placed;
a positioning jig for holding the plurality of ring bodies while maintaining intervals between the ring bodies; and
a moving mechanism for allowing the ring held by the positioning jig to move relative to the placement table, so as to allow the ring bodies to penetrate the binding holes.

2. The ring threading device according to claim 1, wherein the positioning jig includes positioning parts disposed corresponding to the plurality of ring bodies, respectively, so as to position the plurality of ring bodies, and
a connecting part extending in an arrangement direction of the plurality of binding holes of the sheets, so as to connect the plurality of positioning parts.

3. The ring threading device according to claim 1, wherein
the positioning jig is disposed on the same side as the ring with respect to the placement table, and
the moving mechanism allows the ring bodies positioned and held by the positioning jig to move in a first direction relatively to the placement table, and to penetrate the binding holes.

4. The ring threading device according to claim 3, wherein
a first engaging part is formed on each of the plurality of ring bodies, and
the positioning jig has a second engaging part for engaging the first engaging part so that the plurality of ring bodies are positioned and held.

5. The ring threading device according to claim 4, wherein
the first engaging part is a protrusion formed on a tip portion of the ring body so as to protrude from a surface thereof, and
the second engaging part is a recess to engage with the protrusion.

6. The ring threading device according to claim 3, wherein the moving mechanism allows only the ring bodies to penetrate the binding holes.

7. The ring threading device according to claim 6, wherein the ring is formed so that the tip portion of the ring body has higher hardness in a predetermined area than other parts.

8. The ring threading device according to claim 6, wherein
the positioning jig includes a main body for positioning each of the plurality of ring bodies and a holding part for holding the ring bodies positioned by the main body,
the main body extends in the arrangement direction of the plurality of binding holes of the sheets and has a surface with guide grooves in which the plurality of ring bodies are respectively engaged, and
the holding part and the main body sandwich and hold the ring bodies engaged in the guide grooves.

9. The ring threading device according to claim 8, wherein
the main body is a rotatable roller having a surface with the guide grooves in which the plurality of ring bodies are respectively engaged,
the holding part is a rotatable nip roller to sandwich and hold the ring bodies engaged in the guide grooves, between itself and the roller, and
the moving mechanism allows at least one of the roller and the nip roller to rotate.

10. The ring threading device according to claim 8, wherein
the main body is a main body bar having a surface with the guide grooves in which the plurality of ring bodies are respectively engaged, the main body bar being capable of approaching and separating from the placement table,
the holding part is a clamp bar that is capable of approaching and separating from the main body bar and that is capable of approaching and separating from the placement table while sandwiching the ring bodies engaged in the guide grooves, between itself and the main body bar, and
the moving mechanism allows the main body bar and the clamp bar to approach and separate from the placement table.

11. The ring threading device according to claim 2, wherein
the positioning parts of the positioning jig are capable of moving relative to the placement table in a direction crossing a placement surface of the placement table and are capable of penetrating the binding holes of the sheets, and
the moving mechanism allows the ring bodies as well as the positioning parts holding the ring bodies to penetrate the binding holes.

12. The ring threading device according to claim 11, wherein
the positioning jig is disposed on the side opposite to the ring with respect to the placement table, and
the moving mechanism allows the positioning parts of the positioning jig to move relative to the placement table in a first direction so as to penetrate the binding holes, and allows the positioning parts after positioning and holding the ring bodies to move relative to the placement table together with the ring bodies in a second direction, opposite to the first direction, so as to penetrate the binding holes.

13. The ring threading device according to claim 12, wherein the positioning jig includes a pair of holding parts disposed to face each other and to be capable of approaching and separating from each other.

14. The ring threading device according to claim 12, wherein
a first engaging part is formed on each of the plurality of ring bodies, and
the positioning jig includes a second engaging part for engaging the first engaging part so that the plurality of ring bodies are positioned and held.

15. The ring threading device according to claim 1, wherein the moving mechanism moves the ring relative to the placement table from up to down so as to allow the ring bodies to penetrate the binding holes of the sheets.

16. A method for manufacturing a ring notebook, comprising:
a notebook preparation step for preparing a notebook including a plurality of sheets having a plurality of binding holes arranged in a first direction on one end;
a ring preparation step for preparing a ring including a base part extending in the first direction and a plurality of ring bodies extending from the base part in a second direction crossing the first direction;
a ring threading step for allowing the ring bodies of the ring to penetrate the corresponding binding holes of the notebook by using the ring threading device according to claim 1;
a welding step for deforming and bending the ring bodies and for welding the tip portions of the ring bodies to the base part; and
a cutting step for cutting off tip portions from main parts of welded parts between the ring bodies and the base part.
